(19) United States
(12) Patent Application Publication
(10) Pub. No.: US 2013/0294752 A1
(43) Pub. Date: Nov. 7, 2013

(54) Using 3D Simulation Technology To Create Custom Exercise Videos

(71) Applicant: Najwa Sara Merchawi, Troy, MI (US)

(72) Inventor: Najwa Sara Merchawi, Troy, MI (US)

(73) Assignee: DASSAULT SYSTEMES DELMIA CORP., Auburn Hills, MI (US)

(21) Appl. No.: 13/463,652

(22) Filed: May 3, 2012

(51) Int. Cl. H04N 5/91

(52) U.S. Cl. 386/285; 386/290; 386/E05.003

(57) ABSTRACT

A computer-implemented method for generating custom video files includes storing in a memory area a plurality of data points representative of each of a plurality of predefined human postures and, based on at least a portion of the data points, computing a plurality of action sequences, wherein each action sequence includes at least one of the human postures. The method also includes receiving via an input device a user selection of at least one of the action sequences, generating a recording of the action sequence, and creating a video file including the recording.

### BACKGROUND OF THE INVENTION

The embodiments described herein relate generally to creating video files and, more particularly, to using three-dimensional (3D) simulations of human movements to generate video files including simulations of human movements.

Physical therapy is a custom sequence of exercises designed to heal sports and other types of injuries such as those associated with accidents or surgeries. A physical therapist designs the exercise sequence for a client based on the therapist's knowledge and expertise. Then the therapist walks the client through the exercise sequence over a period of several weeks. Upon completion of the sessions, therapist sends the client home with the expectation that the client will continue the exercise sequence at home. The therapist often gives the client various papers having a snapshot of the exercises that the client is supposed to do at home, as a reminder.

However, these pieces of paper often end up wrinkled up in some drawer, and the chances of the patient putting them to good practical use are very small. No known software solution exists to generate custom exercise sequences with a few software clicks. At least some known software used in the physical therapy world is limited to studying the human motion for instructional and research purposes. Physical therapy is only successful if the patient continues his therapy at home. However, patients are not given any tools to help them with this task. They are given paper printouts showing snapshots of the motion they are supposed to do. This solution is ineffective, error prone, and not motivating, therefore it is unlikely that the patient will continue doing the physical therapy exercises from a piece of paper or from memory. The piece of paper is likely to end up wrinkled, lost or damaged. A piece of paper is not an intuitive way to portray motion in this day and age.

### BRIEF DESCRIPTION OF THE INVENTION

In one aspect, a computer-implemented method is provided for use in generating custom video files includes storing in a memory area a plurality of data points representative of a plurality of predefined human postures and, based on at least a portion of the data points, computing a plurality of action sequences, wherein each action sequence includes at least one of the human postures. The method also includes receiving via an input device a user selection of at least one of the action sequences, generating a recording of the action sequence, and creating a video file including the recording.

In another aspect, a computer is provided for use in generating custom video files. The computer includes a memory area configured to store a plurality of data points representative of each of a plurality of predefined human postures. The computer also includes a processor coupled to the memory area. The processor is configured to compute a plurality of action sequences based on at least a portion of the data points, wherein each action sequence includes at least one of the human postures. The processor is also configured to receive from an input device a user selection of at least one action sequence, generate a recording of the action sequence, and create a video file including the recording.

In another aspect, a computer program product includes one or more non-transitory computer-readable storage media having computer-executable components for use in generating custom video files. A simulation component causes a processor to compute a plurality of action sequences based on at least a portion of a plurality of data points stored in a memory area, wherein the data points are representative of a plurality of predefined human postures and each action sequence includes at least one of the human postures. A specification component causes the processor to receive via an input device a user selection of at least one action sequence. A video generation component causes the processor to generate a recording of the action sequence and create a video file including the recording.

### BRIEF DESCRIPTION OF THE DRAWINGS

The details of one or more embodiments of the invention are set forth in the accompanying drawings and the description that follows. Other features, objects, and advantages of the invention will be apparent from the description and drawings, and from the claims.

FIG. 1 is a flowchart illustrating an exemplary method for use in generating custom video files.

FIGS. 2A-2C are images representative of 3D human postures.

FIGS. 3A-3C are images representative of 3D depictions of exercises.

FIG. 4 is a schematic block diagram of an exemplary computer system.

FIG. 5 is a schematic block diagram of an exemplary computer architecture for use with the computer system shown in FIG. 4.

### DETAILED DESCRIPTION OF THE INVENTION

Exemplary embodiments of methods, systems, apparatus, and computer program products for use in generating custom video files are described herein. The embodiments described herein facilitate an easy, fast method for producing a DVD or similar video file containing a custom exercise sequence that a physical therapist can generate with a few clicks on the software. A patient is much more likely to continue his or her therapy, since he or she can simply use the video file with any compatible player and follow the sequence in real time. Human simulation has been developed for the purpose of manufacturing simulation, such that only human actions pertinent to the manufacturing world are available for creation and simulation (i.e. walk, reach, grab, release, etc.). One purpose of such simulations is focused on the following goals: (1) estimating the length of time the human task will take in the manufacturing world, in order to estimate production times; (2) estimating whether the human can reach certain areas of the manufacturing work cell; and (3) estimating the fatigue incurred by the human in performing the tasks (ergonomics).

Embodiments of the invention solves the technical problem by providing cost effective simple software, which, with a few mouse clicks, generates a movie file containing the custom exercise sequence that the patient is to follow. The number of repetitions is included and the total amount of time is taken into account in the movie file. The patient will just have to insert a DVD into a player or play the movie file on any device, and follow along the sequence of exercises in real time. Custom selected music, sounds, and/or an instructional voice can be dubbed in to match the exercise sequence.

Moreover, having a DVD or movie file is a more motivational, accurate, and effective way to continue physical therapy. The patient follows a human being avatar doing the movements on the screen. The avatar performs the same number of repetitions the client is supposed to do and takes the same amount of time that the client is expected to take. Custom selected sounds and/or music are an added bonus and serves as extra motivation to keep the therapy going.

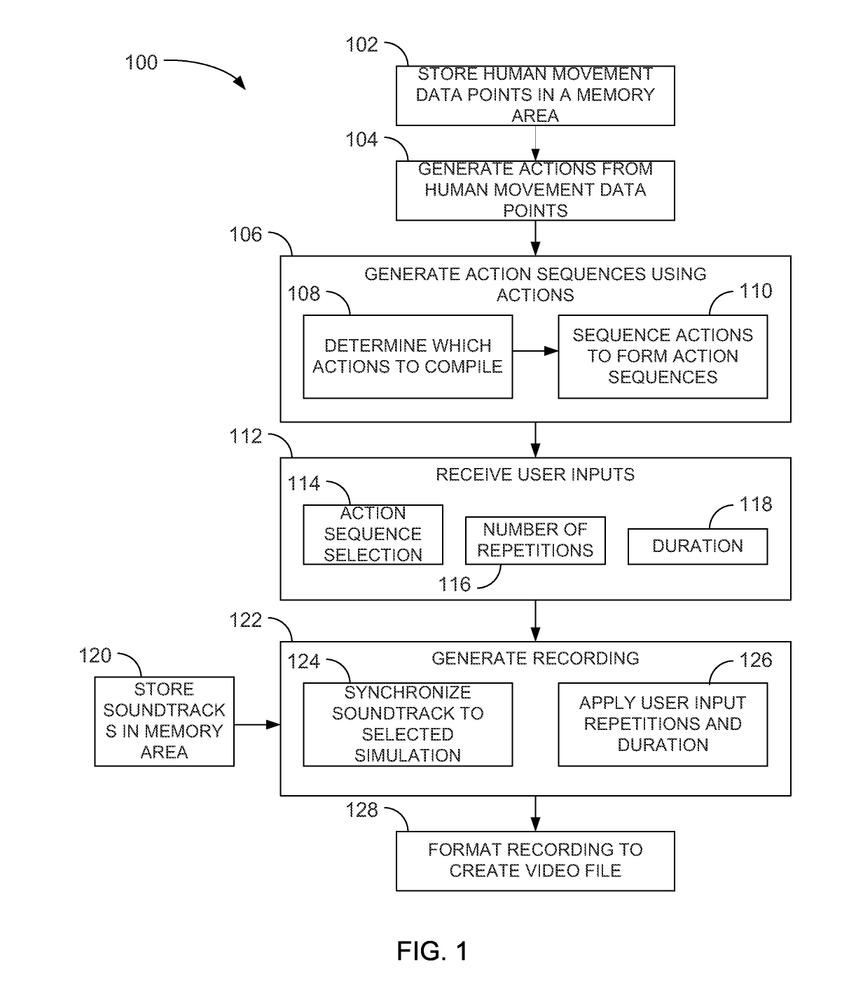

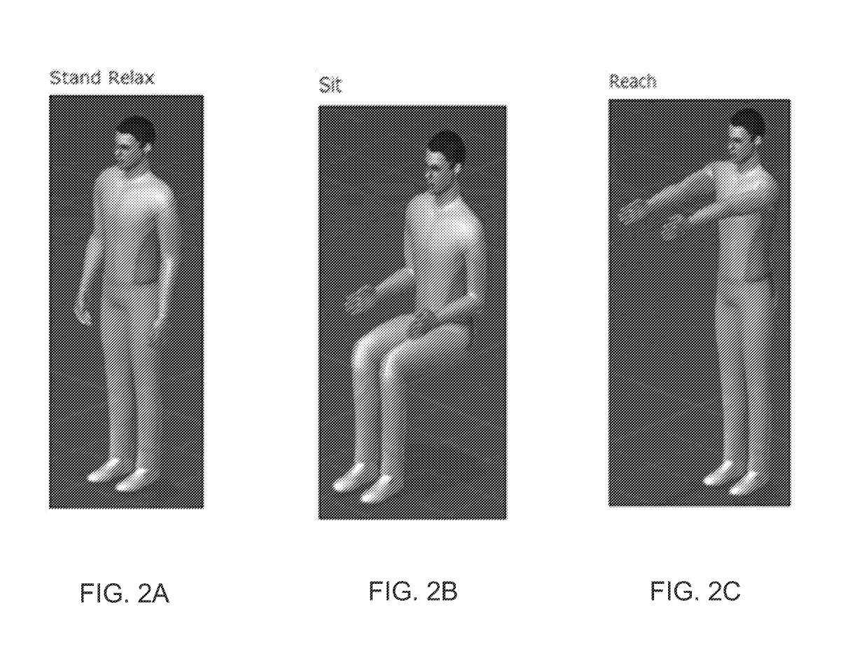

FIG. 1 is a flowchart 100 that illustrates an exemplary method for generating custom video files, such as video files for use in physical therapy or exercise routines. In an exemplary embodiment, a plurality of data points representative of each of a plurality of predefined human postures is stored 102 in a memory area. For example, the human postures may be stored in the memory area using unique names or some other unique identifier. Moreover, the human postures may be stored in the memory area using a unique identifier and then managed via a database, wherein defining characteristics of the human postures are available to a user for display, sorting, searching, and/or selection. The human postures include, but are not limited to only including, a standing posture as shown in FIG. 2A, a sitting posture as shown in FIG. 2B, a reaching posture as shown in FIG. 2C, or any other human posture. In an exemplary embodiment and as shown in FIGS. 2A-2C, the data points represent 3D human postures. However, it should be noted that the invention described herein does not require that the data points represent 3D human postures and can instead represent two-dimensional (2D) human postures.

In an exemplary embodiment, a computer generates 104 a plurality of actions, wherein each action includes at least one of the human postures. In some embodiments, the computer generates the actions by combining one or more of the human postures in a predefined series to reflect a desired movement. For example, the computer may sequence a series of human postures such that a 3D model of a human moves from a sitting position, such as the position shown in FIG. 2B, to a standing position, such as the position shown in FIG. 2A. Similarly, an action can be defined and generated such that a 3D model of a human moves from a standing position, such as the position shown in FIG. 2A, to a sitting position, such as the position shown in FIG. 2B. Actions can also include arm movements by the 3D model of a human, such as reaching as shown in FIG. 2C. The actions may then be stored in the memory area using unique names or some other unique identifier. Moreover, the actions may be stored in the memory area using a unique identifier and then managed via a database, wherein defining characteristics of the actions are available to a user for display, sorting, searching, and/or selection.

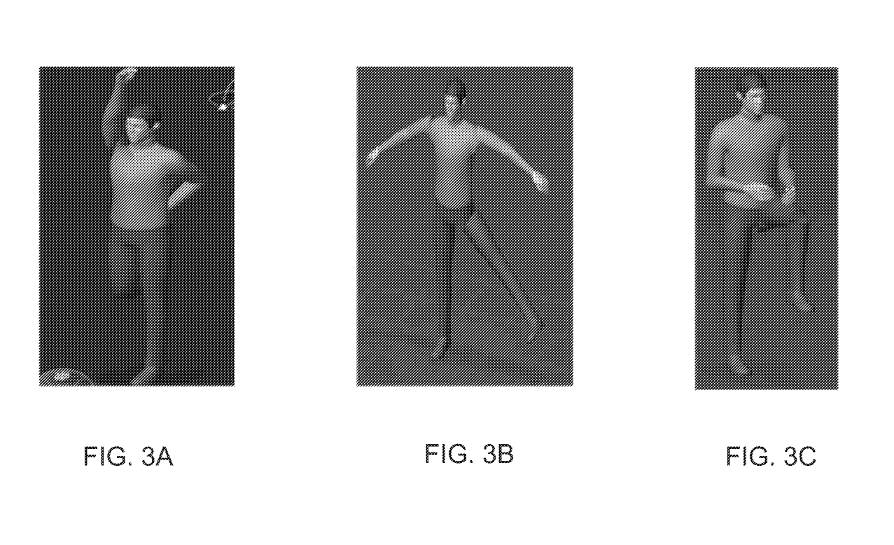

Based on at least a portion of the data points, the computer generates or computes 106 a plurality of action sequences. Each action sequence is made up of one or more actions and, therefore, includes at least one of the human postures. In some embodiments, the computer determines or identifies 108 the actions necessary to form a particular action sequence and then places the identified actions in sequence 110 to form the desired action sequence. For example, the computer may determine a unique identifier of one or more actions necessary for use in generating an action sequence. Each action may then be queued in an order defined by the specifications of a particular action sequence. The computer may then assemble the actions to form the action sequence. In an exemplary embodiment and as shown in FIGS. 3A-3C, the action sequences represent 3D depictions of exercises. However, it should be noted that the invention described herein does not require that the action sequences represent 3D depictions of exercises. Rather, the action sequences may depict any suitable 3D movement, or may represent 2D depictions of exercises or any other suitable movement. The action sequences may then be stored in the memory area using unique names or some other unique identifier. Moreover, the action sequences may be stored in the memory area using a unique identifier and then managed via a database, wherein defining characteristics of the action sequences are available to a user for display, sorting, searching, and/or selection.

In an exemplary embodiment, the computer receives 112 various user inputs via an input device. For example, the computer receives 114 a user selection of one or more action sequences that have been generated 106 from the actions. Moreover, the computer may receive 116 user inputs related to a number of repetitions of the chosen actions and/or a duration of the chosen actions to be portrayed in an output recording. Furthermore, the computer may receive 118 user inputs related to a duration during which the action sequences are to be portrayed in the output recording.

In some embodiments, one or more soundtracks are stored 120 in the memory area. The soundtracks may be stored in the memory area using a unique identifier and then managed via a database, wherein defining characteristics of the soundtracks are available to a user for display, sorting, searching, and/or selection. The soundtracks may include voiceovers for use in relaying instructions in synchronization with the action sequences used in the output recording. Alternatively, or in addition to the voiceovers, the soundtracks may include musical tracks that are synchronized with the action sequences used in the output recording. It should be noted that any other suitable soundtracks may be synchronized with the action sequences. In addition, the soundtracks may be of any suitable file type. For example, and not by way of limitation, the soundtracks, whether musical tracks or voiceovers, may be uncompressed files such as Waveform Audio File Format (WAV) files, Audio Interchange File Format (AIFF) files, or raw or headerless pulse-code modulation (PCM) files. Alternatively, the soundtracks may be losslessly compressed files such as Free Lossless Audio Codec (FLAC) files or Apple Lossless (ALAC) files. Still further, the soundtracks may be lossy compressed files such as MPEG-1 or MPEG-2 Audio Layer III (MP3) files, Vorbis compressed files, or Advanced Audio Coding (AAC) files. It should be noted, however, that the above lists are not meant to be limiting and that any suitable lossless or lossy-compressed files may be used in embodiments of the invention. Moreover, in some embodiments, the action sequences are synchronized with both voiceovers and musical tracks. Furthermore, in some embodiments, the soundtracks may change during an action sequence and/or between two action sequences that are depicted in the output recording.

When the user inputs have been received, the computer generates 122 a recording of the selected action sequences. In some embodiments, the computer determines or identifies the action sequences and soundtracks necessary to form a recording based on the user inputs. The computer then synchronizes the identified action sequences and soundtrack files to generate the recording. For example, the computer may determine a unique identifier of the selected action sequences and soundtracks necessary for use in generating a recording and locate the respective files in the memory area. The computer may then assemble the action sequence and soundtrack files to form the recording. For example, in some embodiments, the computer synchronizes 124 the selected soundtracks to the selected action sequences. Moreover, in some embodiments, the computer stores the recording in the memory area for later access. Furthermore, in some embodiments, the computer applies 126 the user inputs related to repetitions and/or duration when generating the recording.

In an exemplary embodiment, and after creating the recording, the computer creates 128 a video file that includes the recording. For example, in some embodiments, the computer creates the video file by formatting the recording based on a specified format. Exemplary video file formats include, but are not limited to only including, the audio video interleave (AVI) format, the Quicktime format, the MPEG-4 (MP4) format, the Windows Media Video (WMV) format, the MPEG format, or any other suitable video file formats for use with video file players, whether hardware or software. The video file may then be saved to a media, such as a removable hard drive, a DVD, a CD, or any other suitable portable memory media. Moreover, the video file may be saved into the memory area for later access.

In some embodiments, the creation of a video file as described above may be automatic or at least partially automated. For example, in one embodiment, a user inputs observed symptoms and/or doctor or therapist diagnoses, and a computer or computer system outputs a video file including action sequences for use in mediating the symptoms or diagnosed issues.

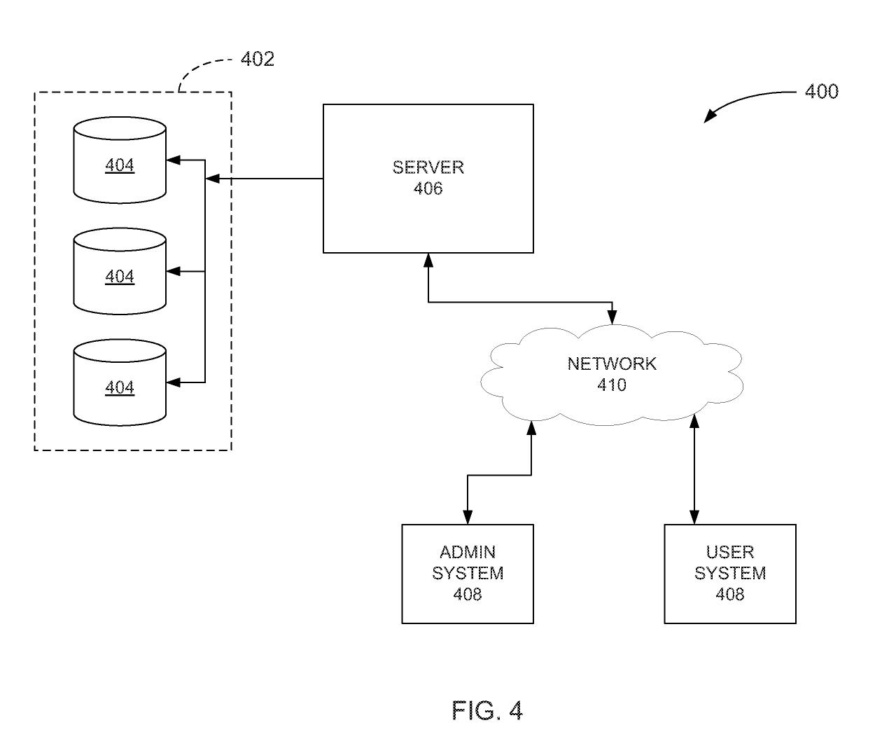

FIG. 4 is a schematic block diagram of an exemplary computer system 400 for use in generating custom video files, such as video files for use in physical therapy or exercise routines, and/or for use in performing the processes described above and/or additional processes that may be related to those described above. In an exemplary embodiment, a memory area 402 includes one or more storage devices 404 for use in storing data, such as data points representative of each of a plurality of predefined human postures; a plurality of actions each including at least one human postures; a plurality of action sequences each including one or more actions; a plurality of soundtracks including voiceovers for use in relaying instructions in synchronization with the action sequences and/or musical tracks that are synchronized with the action sequences; recordings made up of synchronized action sequences, voiceovers, and/or musical tracks; and video files including formatted recordings. Moreover, the memory area 402 may include patient data such as patient identifiers and the like. In some embodiments, the memory area 402 is coupled to a server system 406, which is in turn coupled to client systems 408 such as an administrator system and/or a user system, via a network 410. The storage devices 404 may be embodied as one or more databases, may be located at a single or at multiple geographical sites, or may be integrated with the server system 406.

As can be appreciated, the network 410 can be a public network, such as the Internet, or a private network such as an LAN or WAN network, or any combination thereof and can also include PSTN or ISDN sub-networks. The network 410 can also be wired, such as an Ethernet network, or can be wireless such as a cellular network including EDGE, 3G, and 4G wireless cellular systems. The wireless network can also be WiFi, Bluetooth, or any other wireless form of communication that is known. Thus, the network 410 is merely exemplary and in no way limits the scope of the present advancements.

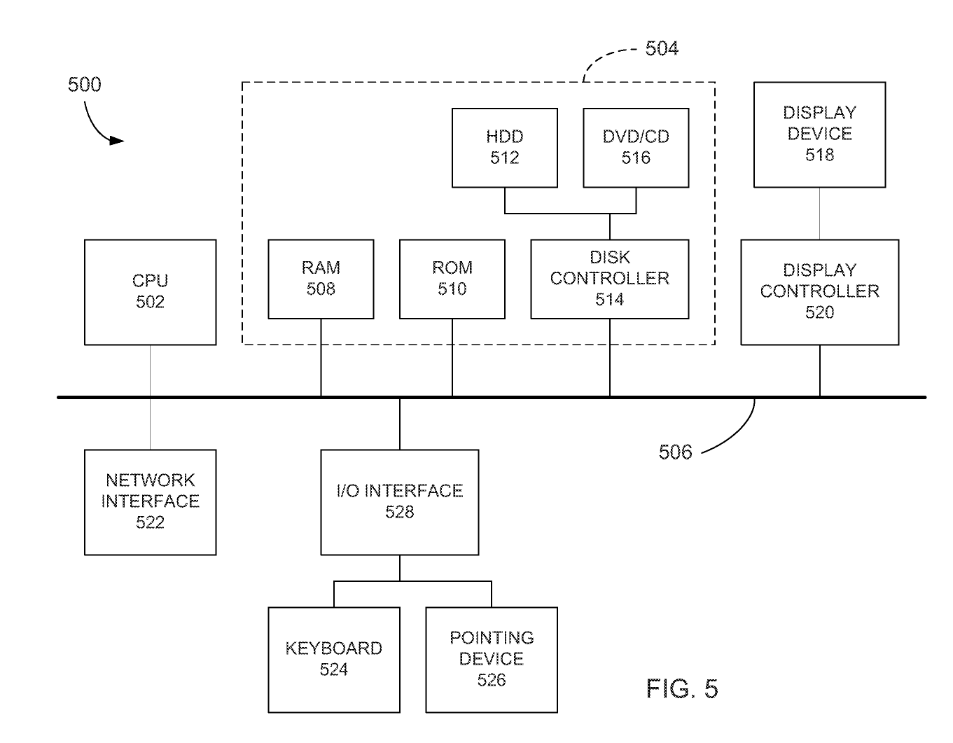

The client systems 408 can be any suitable computer architecture such as the one described below with reference to FIG. 5, or any other computing architecture that is known. Moreover, it should be understood that the server system 406 is configured to perform the processes described above and/or any additional processes that may be related to those described above.

The server system 406 stores the computer-readable instructions to execute the processes described above, and provides these instructions via the network 410 to the client systems 408. Moreover, the server system 406 can also provide data from the memory area 402 as needed to the client systems 408 such that the client systems 408 execute the processes described above. As such, FIG. 4 includes implementations of the computer system 400 via cloud computing, distributed computing, and the like.

During operation, the server system 406, for example, generates the plurality of actions, wherein each action includes at least one of the human postures. In some embodiments, the server system 406 generates the actions by combining one or more of the human postures in a predefined series to reflect a desired movement. The actions may then be stored in the memory area 402 using unique names or some other unique identifier. Moreover, the actions may be stored in the memory area 402 using a unique identifier and then managed via a database, wherein defining characteristics of the actions are available to a user for display, sorting, searching, and/or selection via the client systems 408.

Based on at least a portion of the data points, the server system 406 generates or computes a plurality of action sequences. Each action sequence is made up of one or more actions and, therefore, includes at least one of the human postures. In some embodiments, the server system 406 determines or identifies the actions necessary to form a particular action sequence and then places the identified actions in sequence to form the desired action sequence. For example, the server system 406 may determine a unique identifier of one or more actions necessary for use in generating a action sequence. Each action may then be queued in an order defined by the specifications of a particular action sequence. The server system 406 may then assemble the actions to form the action sequence. The action sequences may then be stored in the memory area 402 using unique names or some other unique identifier. Moreover, the action sequences may be stored in the memory area 402 using a unique identifier and then managed via a database, wherein defining characteristics of the action sequences are available to a user for display, sorting, searching, and/or selection via the client systems 408.

In an exemplary embodiment, the server system 406 receives various user inputs from the client systems 408 via the network 410. For example, the server system 406 receives from the client systems 408 a user selection of one or more action sequences that have been generated from the actions. Moreover, the server system 406 may receive from the client systems 408 user inputs related to a number of repetitions of the chosen action sequences to be portrayed in an output recording. Furthermore, the server system 406 may receive from the client systems 408 user inputs related to a duration during which the action sequences are to be portrayed in the output recording. In addition, the server system 406 may receive from the client systems 408 user inputs related to a duration of each action within a chosen action sequence.

When the user inputs have been received, the server system 406 generates a recording of the selected action sequences. In some embodiments, the server system 406 determines or identifies the action sequences and soundtracks necessary to form a recording based on the user inputs. The server system 406 then synchronizes the identified action sequences and soundtrack files to generate the recording. For example, the server system 406 may determine a unique identifier of the selected action sequences and soundtracks necessary for use in generating a recording and locate the respective files in the memory area 402. The server system 406 may then assemble the action sequence and soundtrack files to form the recording. For example, in some embodiments, the server system 406 synchronizes the selected soundtracks to the selected action sequences. Moreover, in some embodiments, the server system 406 stores the recording in the memory area 402 for later access.

In an exemplary embodiment, and after creating the recording, the server system 406 creates a video file that includes the recording. For example, in some embodiments, the server system 406 creates the video file by formatting the recording based on a specified format. The video file may then be saved to a media, such as a removable hard drive, a DVD, a CD, or any other suitable portable memory media. Moreover, the video file may be saved into the memory area 402 for later access.

FIG. 5 is a schematic block diagram of an exemplary computer architecture 500 for use with the server system 406 and/or the client systems 408 (each shown in FIG. 4).

In an exemplary embodiment, the computer architecture 500 includes one or more processors 502 (CPU) that performs the processes described above and/or any additional processes that may be related to those described above. It should be understood that the term “processor” refers generally to any programmable system including systems and microcontrollers, reduced instruction set circuits (RISC), application-specific integrated circuits (ASIC), programmable logic circuits, and/or any other circuit or processor capable of executing the functions described herein. The above examples are exemplary only and, thus, are not intended to limit in any way the definition and/or meaning of the term “processor.”

The steps of the processes described above and/or any additional processes that may be related to those described above may be stored as computer-executable instructions in, for example, a memory area 504 that is operably and/or communicatively coupled to the processor 502 by a system bus 506. A “memory area,” as used herein, refers generally to any means of storing non-transitory program code and instructions executable by one or more processors to aid in generating custom video files, such as video files for use in physical therapy and/or exercise routines, and/or for use in performing the processes described above and/or additional processes that may be related to those described above. The memory area 504 may include one, or more than one, forms of memory. For example, the memory area 504 may include random-access memory (RAM) 508, which can include non-volatile RAM, magnetic RAM, ferroelectric RAM, and/or other forms of RAM. The memory area 504 may also include read-only memory (ROM) 510 and/or flash memory and/or electrically-programmable read-only memory (EEPROM). Any other suitable magnetic, optical, and/or semiconductor memory, such as a hard-disk drive (HDD) 512, by itself or in combination with other forms of memory, may be included in the memory area 504. The HDD 512 may also be coupled to a disk controller 514 for use in transmitting and receiving messages to and from the processor 502. Moreover, the memory area 504 may also be, or may include, a detachable or removable memory 516, such as a suitable cartridge disk, CD-ROM, DVD, or USB memory. The above examples are exemplary only and, thus, are not intended to limit in any way the definition and/or meaning of the term “memory area.”

The computer architecture 500 also includes a display device 518 that is coupled, such as operatively coupled, to a display controller 520. The display controller 520 receives data via the system bus 506 for display by the display device 518. The display device 518 may be, without limitation, a monitor, a television display, a plasma display, a liquid crystal display (LCD), a display based on light-emitting diodes (LED), a display based on organic LEDs (OLED), a display based on polymer LEDs, a display based on surface-conduction electron emitters, a display including a projected and/or reflected image, or any other suitable electronic device or display mechanism. Moreover, the display device 518 may include a touchscreen with an associated touchscreen controller 522. The above examples are exemplary only and, thus, are not intended to limit in any way the definition and/or meaning of the term “display device.”

In addition, the computer architecture 500 includes a network interface 522 for use in communicating with a network (not shown in FIG. 5). Moreover, the computer architecture 500 includes one or more input devices, such as a keyboard 524 and/or a pointing device 526, such as a roller ball, mouse, touchpad, and the like. The input devices are coupled to and controlled by an input/output (I/O) interface 528, which is further coupled to the system bus 506.

A description of the general features and functionality of the display device 518, keyboard 524, pointing device 526, as well as the display controller 520, disk controller 514, network interface 522, and I/O interface 528 is omitted herein for brevity as these features are known.

During operation, the processor 502, for example, generates the plurality of actions, wherein each action includes at least one of the human postures. In some embodiments, the processor 502 generates the actions by combining one or more of the human postures in a predefined series to reflect a desired movement. The actions may then be stored in the memory area 504 using unique names or some other unique identifier. Moreover, the actions may be stored in the memory area 504 using a unique identifier and then managed via a database, wherein defining characteristics of the actions are available to a user for display, sorting, searching, and/or selection via the keyboard 524 and/or the pointing device 526.

Based on at least a portion of the data points, the processor 502 generates or computes a plurality of action sequences. Each action sequence is made up of one or more actions and, therefore, includes at least one of the human postures. In some embodiments, the processor 502 determines or identifies the actions necessary to form a particular action sequence and then places the identified actions in sequence to form the desired action sequence. For example, the processor 502 may determine a unique identifier of one or more actions necessary for use in generating a action sequence. Each action may then be queued in an order defined by the specifications of a particular action sequence. The processor 502 may then assemble the actions to form the action sequence. The action sequences may then be stored in the memory area 504 using unique names or some other unique identifier. Moreover, the action sequences may be stored in the memory area 504 using a unique identifier and then managed via a database, wherein defining characteristics of the action sequences are available to a user for display, sorting, searching, and/or selection via the keyboard 524 and/or the pointing device 526.

In an exemplary embodiment, the processor 502 receives various user inputs via the keyboard 524 and/or the pointing device 526. For example, the processor 502 receives a user selection of one or more action sequences that have been generated from the actions. Moreover, the processor 502 may receive user inputs related to a number of repetitions of the chosen action sequences to be portrayed in an output recording. Furthermore, the processor 502 may receive user inputs related to a duration during which the action sequences are to be portrayed in the output recording. In addition, the server system 406 may receive from the client systems 408 user inputs related to a duration of each action within a chosen action sequence.

When the user inputs have been received, the processor 502 generates a recording of the selected action sequences. In some embodiments, the processor 502 determines or identifies the action sequences and soundtracks necessary to form a recording based on the user inputs. The processor 502 then synchronizes the identified action sequences and soundtrack files to generate the recording. For example, the processor 502 may determine a unique identifier of the selected action sequences and soundtracks necessary for use in generating a recording and locate the respective files in the memory area 504. The processor 502 may then assemble the action sequence and soundtrack files to form the recording. For example, in some embodiments, the processor 502 synchronizes the selected soundtracks to the selected action sequences. Moreover, in some embodiments, the processor 502 stores the recording in the memory area 504 for later access.

In an exemplary embodiment, and after creating the recording, the processor 502 creates a video file that includes the recording. For example, in some embodiments, the processor 502 creates the video file by formatting the recording based on a specified format. The video file may then be saved to a media, such as a removable hard drive, a DVD, a CD, or any other suitable portable memory media. Moreover, the video file may be saved into the memory area 504 for later access.

Exemplary embodiments of methods, systems, apparatus, and computer program products for use in generating custom video files, such as video files for use in physical therapy and/or exercise routines, are described above in detail. The methods, systems, apparatus, and computer program products are not limited to the specific embodiments described herein but, rather, operations of the methods and/or components of the system and/or apparatus may be utilized independently and separately from other operations and/or components described herein. Further, the described operations and/or components may also be defined in, or used in combination with, other systems, methods, and/or apparatus, and are not limited to practice with only the systems, methods, and storage media as described herein.

A computer system or server system, such as those described herein, includes at least one processor or processing unit and a system memory. The computer system or server system typically has at least some form of computer readable media. By way of example and not limitation, computer readable media include computer storage media and communication media. Computer storage media include volatile and nonvolatile, removable and non-removable media implemented in any method or technology for storage of information such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Combinations of any of the above are also included within the scope of computer readable media.

In an exemplary embodiment, a computer program product includes one or more non-transitory computer-readable storage media having computer-executable components for use in generating custom video files. The components include, for example, a simulation component that causes a processor, such as server system 406 (shown in FIG. 4) or processor 502 (shown in FIG. 5), to compute a plurality of action sequences based on at least a portion of a plurality of data points stored in a memory area, such as memory area 402 (shown in FIG. 4) or memory area 504 (shown in FIG. 5). In an exemplary embodiment, the data points are representative of a plurality of predefined human postures and each action sequence includes at least one of the human postures. The simulation component also causes the processor to generate a plurality of actions, wherein each action includes at least one of the human postures. Moreover, the simulation component causes the processor to identify one or more actions and to sequence or arrange the one or more actions to form a respective action sequence.

The components also include a specification component that causes the processor to receive via an input device, such as keyboard 524 or pointing device 526 (both shown in FIG. 5), a user selection of one or more action sequences and one more soundtracks. In some embodiments, the specification component also causes the processor to receive user inputs related to a number of repetitions of the selected action sequences to be portrayed in the recording and to receive user inputs related to a duration during which the selected action sequences are to be portrayed in the recording. Moreover, in some embodiments, the specification component also causes the processor to receive user inputs related to a duration of each action within a chosen action sequence.

In an exemplary embodiment, the components also include a video generation component that causes the processor to generate a recording of the selected action sequences and to create a video file including the recording. In some embodiments, the video generation component also causes the processor to synchronize one or more soundtracks to the selected action sequences while generating the recording. Moreover, in some embodiments, the video generation component causes the processor to create a video file by formatting the recording based on a specified format.

Embodiments of the invention may be described in the general context of computer-executable instructions, such as program components or modules, executed by one or more computers or other devices. Aspects of the invention may be implemented with any number and organization of components or modules. For example, aspects of the invention are not limited to the specific computer-executable instructions or the specific components or modules illustrated in the figures and described herein. Alternative embodiments of the invention may include different computer-executable instructions or components having more or less functionality than illustrated and described herein.

The order of execution or performance of the operations in the embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or embodiments thereof, the articles “a,” “an,” “the,” and “said” are intended to mean that there are one or more of the elements. The terms “comprising,” including,” and “having” are intended to be inclusive and mean that there may be additional elements other than the listed elements.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A computer-implemented method for generating custom video files, said computer-implemented method comprising:
storing in a memory area a plurality of data points representative of each of a plurality of predefined human postures;
based on at least a portion of the plurality of data points, computing a plurality of action sequences, each action sequence of the plurality of action sequences including at least one of the plurality of human postures;
receiving via an input device a user selection of at least one action sequence of the plurality of action sequences;
generating a recording of the at least one action sequence; and
creating a video file including the recording.

2. A computer-implemented method in accordance with claim 1, wherein computing a plurality of action sequences comprises generating a plurality of actions, each action of the plurality of actions including at least one of the plurality of human postures.

3. A computer-implemented method in accordance with claim 2, wherein computing a plurality of action sequences further comprises:
identifying at least one action of the plurality of actions; and
sequencing the at least one action to form a respective action sequence.

4. A computer-implemented method in accordance with claim 2, further comprising receiving user inputs related to a number of repetitions of the at least one action to be portrayed in the at least one action sequence.

5. A computer-implemented method in accordance with claim 1, further comprising receiving user inputs related to a duration during which the at least one action sequence is to be portrayed in the recording.

6. A computer-implemented method in accordance with claim 1, further comprising:
storing at least one soundtrack in the memory area; and
synchronizing the at least one soundtrack to the at least one action sequence in the recording.

7. A computer-implemented method in accordance with claim 1, wherein creating a video file comprises formatting the recording based on a specified format.

8. A computer for use in generating custom video files, said computer comprising:
a memory area configured to store a plurality of data points representative of each of a plurality of predefined human postures;
a processor coupled to said memory area, said processor configured to:
based on at least a portion of the plurality of data points, compute a plurality of action sequences, each action sequence of the plurality of action sequences including at least one of the plurality of human postures;
receive from an input device a user selection of at least one action sequence of the plurality of action sequences;
generate a recording of the at least one action sequence; and
create a video file including the recording.

9. A computer in accordance with claim 8, wherein said processor is further configured to generate a plurality of actions, each action of the plurality of actions including at least one of the plurality of human postures.

10. A computer in accordance with claim 9, wherein said processor is further configured to:
identify in said memory area at least one action of the plurality of actions; and
sequence the at least one action to form a respective action sequence.

11. A computer in accordance with claim 9, wherein said processor is further configured to receive user inputs related to a number of repetitions of the at least one action to be portrayed in the at least one action sequence.

12. A computer in accordance with claim 9, wherein said processor is further configured to receive user inputs related to at least one of a duration during which the at least one action is to be portrayed in the at least one action sequence and a duration during which the at least one action sequence is to be portrayed in the recording.

13. A computer in accordance with claim 8, wherein said memory area is further configured to store at least one soundtrack, and said processor is further configured to synchronize the at least one soundtrack to the at least one action sequence in the recording.

14. A computer in accordance with claim 13, wherein the at least one soundtrack is a voiceover for use in relaying instructions in synchronization with the at least one action sequence.

15. A computer in accordance with claim 13, wherein the at least one soundtrack is a musical track in synchronization with the at least one action sequence.

16. A computer in accordance with claim 8, wherein said processor is further configured to format the recording based on a specified format to create the video file.

17. A computer in accordance with claim 8, wherein each of the plurality of predefined human postures corresponds to a physical therapy exercise posture.

18. A computer program product comprising:
one or more non-transitory computer-readable storage media having computer-executable components for use in generating custom video files, said components comprising:
a simulation component that when executed by a processor causes the processor to compute a plurality of action sequences based on at least a portion of a plurality of data points stored in a memory area, wherein the plurality of data points is representative of a plurality of predefined human postures and each action sequence of the plurality of action sequences includes at least one of the plurality of human postures;
a specification component that when executed by the processor causes the processor to receive via an input device a user selection of at least one action sequence of the plurality of action sequences; and
a video generation component that when executed by the processor causes the processor to:
generate a recording of the at least one action sequence; and
create a video file including the recording.

19. A computer program product in accordance with claim 18, wherein said simulation component further causes the processor to generate a plurality of actions, each action of the plurality of actions including at least one of the plurality of human postures.

20. A computer program product in accordance with claim 19, wherein said simulation component further causes the processor to:
identify at least one action of the plurality of actions; and
sequence the at least one action to form a respective action sequence.

21. A computer program product in accordance with claim 19, wherein said specification component further causes the processor to:
receive user inputs related to a number of repetitions of the at least one action to be portrayed in the action sequence; and
receive user inputs related to at least one of a duration during which the at least one action is to be portrayed during the at least one action sequence and a duration during which the at least one action sequence is to be portrayed in the recording.

22. A computer program product in accordance with claim 18, wherein said video generation component further causes the processor to synchronize at least one soundtrack to the at least one action sequence in the recording.

23. A computer program product in accordance with claim 18, wherein said video generation component further causes the processor to create a video file by formatting the recording based on a specified format.

24. The method of claim 1, wherein each of the plurality of predefined human postures corresponds to a physical therapy exercise posture.

25. The computer program product of claim 18, wherein each of the plurality of predefined human postures corresponds to a physical therapy exercise posture.

26. The method of claim 1, wherein each of the plurality of predefined human postures corresponds to a three-dimensional (3D) physical therapy exercise posture.
